(19) United States
(12) Patent Application Publication
(10) Pub. No.: US 2013/0221675 A1
(43) Pub. Date: Aug. 29, 2013

(54) GAS TURBINE COMBINED POWER GENERATION SYSTEM WITH HIGH TEMPERATURE FUEL CELL AND OPERATING METHOD THEREOF

(71) Applicant: Hiroyuki OZAWA, Tokyo (JP)

(72) Inventor: Hiroyuki OZAWA, Tokyo (JP)

(73) Assignee: MITSUBISHI HEAVY INDUSTRIES, LTD., Tokyo (JP)

(21) Appl. No.: 13/766,929

(22) Filed: Feb. 14, 2013

(30) Foreign Application Priority Data
Feb. 29, 2012 (JP) 2012-044823

(51) Int. Cl. F02C 1/00

(52) U.S. Cl. CPC F02C 1/00
USPC 290/54

(57) ABSTRACT

A gas turbine combined power generation system with a high temperature fuel cell is provided, in which stable combustion occurs in a combustor of the gas turbine even during transient periods when the gas turbine operating pressure varies. A control unit adjusts the fuel gas quantity supplied to the high temperature fuel cell main unit by applying a load corresponding to the load of the gas turbine system to the high temperature fuel cell main unit as a normal load command value. When the pressure of the air supplied to the high temperature fuel cell main unit via the air supply line is increasing or decreasing transiently, the control unit applies the load that is applied to the high temperature fuel cell main unit as a pressure increasing period load command value or as a pressure decreasing period load command value, respectively.

### CROSS-REFERENCE TO RELATED APPLICATIONS

This application is based on Japanese Patent Application No. 2012-044823, the contents of which are incorporated herein by reference.

### FIELD OF THE INVENTION

The present invention relates to a gas turbine combined power generation system with a high temperature fuel cell, for example, a solid oxide fuel cell, and an operating method thereof.

### DESCRIPTION OF THE RELATED ART

High temperature fuel cells, for example, solid oxide fuel cells (SOFC), are known as high efficiency fuel cells.

In this type of high temperature fuel cell, the operating temperature is raised in order to increase the ionic conductivity. Therefore, discharge air that is discharged from a compressor of a gas turbine system and is heated to a high temperature using the waste heat of a gas turbine can be used as the air (oxidizing agent) supplied to an air electrode side. High temperature discharge fuel that could not be used in the high temperature fuel cell can also be used as fuel for the combustor of the gas turbine.

Therefore, as disclosed in, for example, Japanese Laid-open Paten Publication No. 2003-36872, a combined power generation system that combines a solid oxide fuel cell and a gas turbine has been proposed as a power generation system that can achieve high efficiencies.

In Japanese Laid-open Paten Publication No. 2003-36872, discharge fuel gas and air discharged from the fuel cell are guided to the gas turbine combustor. In addition, fuel gas delivered by a fuel gas delivery section 8 (see FIG. 1) is directly supplied as auxiliary fuel gas to the combustor of the gas turbine, bypassing the fuel cell, so that the fuel gas supplied to the gas turbine combustor is not insufficient.

### SUMMARY OF THE INVENTION

However, even if auxiliary fuel gas is supplied to the gas turbine combustor as in Japanese Laid-open Paten Publication No. 2003-36872, if the operating pressure of the gas turbine varies, the following problems occur.

When the operating pressure of a gas turbine is increased in order to increase the load of the gas turbine, the degree of opening of an intake air flow rate control vane for a compressor (the so-called inlet guide vane, hereafter referred to as “IGV”) may be increased in order to increase the compressor intake air flow rate. When the degree of opening of the IGV is increased, the discharge air flow rate of the compressor increases, and the compressor outlet pressure increases, and the increased quantity of discharge air is first guided to the fuel cell. However, the volume within the fuel cell system is generally larger than the volume within the gas turbine system; so when the discharge air flow rate is increased, initially the air is consumed just accumulating in the fuel cell in order to increase the pressure, and air and discharge fuel gas are not discharged from the fuel cell with good responsiveness. As a result, the air and discharge fuel gas guided to the combustor of the gas turbine will not reach the required value, and therefore there is a possibility that stable combustion does not occur in the combustor of the gas turbine due to change in the ratio of the discharge fuel gas and auxiliary fuel gas, namely, the fuel composition.

On the other hand, when the operating pressure of the gas turbine is reduced in order to reduce the load of the gas turbine, the degree of opening of the IGV of the compressor is reduced in order to reduce the compressor intake air flow rate. When the degree of opening of the IGV is reduced, the discharge air flow rate of the compressor is reduced, and the compressor outlet pressure reduces, and the reduced flow rate discharge air is first guided to the fuel cell. However, the volume within the fuel cell system is generally larger than the volume within the gas turbine system, so even when the discharge air flow rate is reduced, the gas held within the fuel cell that is already at a high pressure is pressed out. As a result, the air and discharge fuel gas guided to the gas turbine combustor is excessive, and therefore there is a possibility that stable combustion does not occur in the gas turbine combustor due to change in the ratio of the discharge fuel gas and the auxiliary fuel gas, namely, the fuel composition.

As described above, during the transient periods when the gas turbine operating pressure is increased or decreased, the fuel composition supplied to the combustor of the gas turbine is changed, so combustion becomes unstable, and there is a possibility of problems such as combustion vibrations, accidental fires, or increase in NOx.

It is an object of the present invention to provide a gas turbine combined power generation system with a high temperature fuel cell and an operating method thereof, in which stable combustion occurs in the combustor of the gas turbine even during transient periods when the gas turbine operating pressure varies.

The combined power generation system with a high temperature fuel cell according to the present invention is a combined power generation system that includes a gas turbine system and a high temperature fuel cell. The gas turbine system includes a compressor, a combustor, a gas turbine, and a generator. Such a combined power generation system includes: a high temperature fuel cell main unit to which fuel gas and air are supplied and that generates electrical power; a fuel gas supply line that supplies fuel gas from a fuel gas source to the high temperature fuel cell main unit; a fuel gas discharge line that guides discharge fuel gas discharged from the high temperature fuel cell main unit to the combustor; an air supply line that supplies discharge air from the compressor to the high temperature fuel cell main unit; an air discharge line that guides discharge air discharged from the high temperature fuel cell main unit to the combustor; an auxiliary fuel gas supply line that supplies fuel gas to the combustor separately from the fuel gas discharge line; and a control unit that adjusts the fuel gas quantity supplied to the high temperature fuel cell main unit by applying a load corresponding to the load of the gas turbine system to the high temperature fuel cell main unit as a normal load command value, wherein, during pressure increasing periods when the pressure of the air supplied to the high temperature fuel cell main unit via the air supply line is increasing transiently, the control unit increases the load applied to the high temperature fuel cell main unit by increasing the normal load command value by a specific value as a pressure increasing period load command value, and/or, during pressure decreasing periods when the pressure of the air supplied to the high temperature fuel cell main unit via the air supply line is decreasing transiently, the control unit decreases the load applied to the high temperature fuel cell main unit by decreasing the normal load command value by a specific value as a pressure decreasing period load command value.

In the high temperature fuel cell main unit, electrical power is generated from the fuel gas guided from a fuel gas source and air guided from the compressor of the gas turbine system. At this time, the load of the high temperature fuel cell main unit is applied as the normal load command value corresponding to the load of the gas turbine system (for example, a specific proportion of the load of the gas turbine system). The fuel gas flow rate supplied to the high temperature fuel cell main unit is determined in accordance with the applied normal load command value.

Discharge fuel gas discharged from the high temperature fuel cell main unit, auxiliary fuel gas guided from the auxiliary fuel gas supply line, and discharge air discharged from the high temperature fuel cell main unit are guided to the combustor of the gas turbine system and burned. The combustion gases generated in the combustor are guided to the gas turbine and the gas turbine rotates, and the generator is driven by the rotational power of the gas turbine and electrical power is generated.

Generally, the high temperature fuel cell has a large volume within the system compared with the volume within the gas turbine system. Therefore, even when the air and fuel gas supplied within the high temperature fuel cell main unit are increased in order to increase the pressure within the gas turbine system, the supplied air and fuel gas is accumulated and consumed just for increasing the pressure within the high temperature fuel cell main unit when initially the quantity of air and fuel gas supplied is increased, so there is a possibility that the discharge fuel gas and the discharge air supplied to the gas turbine will not reach the required value. As a result, the flow rate of discharge fuel gas in the combustor varies relative to the auxiliary fuel gas, so the fuel composition changes, and there is a possibility that this will result in unstable combustion.

Therefore, in the present invention, during pressure increasing periods when the pressure of the air supplied to the high temperature fuel cell main unit is increasing transiently, the normal load command value as described above is increased by a specific value and applied as a pressure increasing period load command value, so the flow rate of discharge fuel gas corresponding to the load which is increased relative to the normal load command value is increased and supplied to within the high temperature fuel cell main unit. As a result, during times of increasing pressure, it is possible to increase the flow rate of discharge fuel gas supplied from high temperature fuel cell main unit, so it is possible to maintain the flow rate of discharge fuel gas approximately constant relative to the auxiliary fuel gas.

On the other hand, as stated above, generally, the high temperature fuel cell has a large volume within the system compared with the volume within the gas turbine. Therefore, even when the air and fuel gas supplied within the high temperature fuel cell main unit are decreased in order to decrease the pressure within the gas turbine system, when initially the quantity of air and fuel gas supplied is decreased, the pressure of the air and fuel gas already retained within the high temperature fuel cell main unit is still high. Therefore, the discharge air and the discharge fuel gas are pressed out and are excessively supplied toward the gas turbine side, so the fuel gas and air supplied to the gas turbine is temporarily increased over the required value. As a result, the flow rate of discharge fuel gas in the combustor varies relative to the auxiliary fuel gas, so the fuel composition changes, and there is a possibility that this will result in unstable combustion.

Therefore, in the present invention, during pressure increasing periods when the pressure of the air supplied to the high temperature fuel cell main unit is decreasing transiently, the normal load command value as described above is decreased by a specific value and applied as a pressure decreasing period load command value, so the flow rate of discharge fuel gas corresponding to the load which is decreased relative to the normal load command value is decreased and supplied to within the high temperature fuel cell main unit. As a result, during times of decreasing pressure, it is possible to decrease the flow rate of discharge fuel gas supplied from high temperature fuel cell main unit, so it is possible to maintain the flow rate of discharge fuel gas approximately constant relative to the auxiliary fuel gas.

In this way, according to the present invention, when the pressure of the air supplied to the high temperature fuel cell main unit is transiently increased or decreased, it is possible to control the ratio of the discharge fuel gas and the auxiliary fuel gas supplied to the combustor of the gas turbine system, namely, the fuel composition, to be approximately constant. Therefore, it is possible to avoid unstable combustion, an increase in NOx in the combustor, combustion vibrations, accidental fires, and the like.

The high temperature fuel cell is typically a solid oxide fuel cell (SOFC) or a molten carbonate fuel cell (MCFC).

In addition, in the combined power generation system according to the present invention, the control unit may detect the transient change in pressure of the air supplied to the high temperature fuel cell main unit based on the change in the degree of opening of the flow rate control vane that controls the intake air flow rate of the compressor.

The flow rate of the air discharged from the compressor varies in accordance with the variation in the degree of opening of the flow rate control vane that controls the intake air flow rate to the compressor of the gas turbine system. Therefore, the transient change in pressure of the air supplied to the high temperature fuel cell main unit is detected based on the change in the degree of opening of flow rate control vanes.

The change in the degree of opening of the flow rate control vanes may be directly measured from the degree of opening using a degree of opening sensor, or it may be estimated by calculation from the load rate of change command value applied to the gas turbine system 5.

In addition, in the combined power generation system according to the present invention, the control unit may detect the transient change in pressure of the air supplied to the high temperature fuel cell main unit based on the load rate of change command value applied to the gas turbine system.

The flow rate of the air discharged from the compressor varies in accordance with the change in load applied to the gas turbine system. Therefore, the transient change in pressure of the air supplied to the high temperature fuel cell main unit is detected based on the load rate of change command value applied to the gas turbine system. In this way, the load rate of change command value, which is an antecedent command value of the flow rate control vane, is used, so it is possible to increase the responsiveness.

The change in pressure of the air supplied to the high temperature fuel cell main unit may be directly estimated by calculation based on the load rate of change command value of the gas turbine system, or, the change in the degree of opening of the flow rate control vane of the compressor may be estimated by calculation based on the load rate of change command value of the gas turbine system, and the change in pressure of the air supplied to the high temperature fuel cell main unit may be detected from the change in the degree of opening of the flow rate control vanes.

In addition, in the combined power generation system according to the present invention, the control unit may detect the transient change in pressure of the air supplied to the high temperature fuel cell main unit based on the air supply line pressure.

The change in pressure of the air supplied to the high temperature fuel cell main unit corresponds to the change in pressure of the air supply line. Therefore, the transient change in pressure of the air supplied to the high temperature fuel cell main unit is directly detected based on the change in pressure of the air supply line. As a result, it is possible to carry out control with high accuracy.

To detect the change in pressure of the air supply line, preferably a pressure sensor is installed in the air supply line, and the position of installation of the pressure sensor may be near the compressor outlet, or near the high temperature fuel cell main unit inlet.

The combined power generation system operating method according to the present invention is a method of operating a combined power generation system that includes a gas turbine system and a high temperature fuel cell. The gas turbine system includes a compressor, a combustor, a gas turbine, and a generator. In such an operating method, the combined power generation system includes: a high temperature fuel cell main unit to which fuel gas and air are supplied and that generates electrical power; a fuel gas supply line that supplies fuel gas from a fuel gas source to the high temperature fuel cell main unit; a fuel gas discharge line that guides discharge fuel gas discharged from the high temperature fuel cell main unit to the combustor; an air supply line that supplies discharge air from the compressor to the high temperature fuel cell main unit; an air discharge line that guides discharge air discharged from the high temperature fuel cell main unit to the combustor; an auxiliary fuel gas supply line that supplies fuel gas to the combustor separately from the fuel gas discharge line; and a control unit that adjusts the fuel gas quantity supplied to the high temperature fuel cell main unit by applying a load corresponding to the load of the gas turbine system to the high temperature fuel cell main unit as a normal load command value, and during pressure increasing periods when the pressure of the air supplied to the high temperature fuel cell main unit via the air supply line is increasing transiently, the control unit increases the load applied to the high temperature fuel cell main unit by increasing the normal load command value by a specific value as a pressure increasing period load command value, and/or, during pressure decreasing periods when the pressure of the air supplied to the high temperature fuel cell main unit via the air supply line is decreasing transiently, the control unit decreases the load applied to the high temperature fuel cell main unit by decreasing the normal load command value by a specific value as a pressure decreasing period load command value.

According to the present invention, when the pressure within the high temperature fuel cell main unit is transiently increased or decreased, it is possible to control the ratio of the discharge fuel gas and the auxiliary fuel gas (namely, the fuel composition) supplied to the combustor of the gas turbine system, to be approximately constant. Therefore, it is possible to avoid unstable combustion, and to prevent an increase in NOx, combustion vibrations, accidental fires, and the like, in the combustor.

### BRIEF DESCRIPTION OF THE DRAWINGS

FIG. 1

A schematic view illustrating a high temperature fuel cell gas turbine combined power generation system of a first embodiment according to the present invention.

FIG. 2

A graph showing the changes to lead increased pressure.

FIG. 3

A graph showing the changes to lead decreased pressure.

FIG. 4

A control block diagram showing the control to detect a change in the pressure.

FIG. 5

A control block diagram showing the control to detect a change in pressure of a high temperature fuel cell gas turbine combined power generation system according to a second embodiment.

FIG. 6

A schematic view illustrating a high temperature fuel cell gas turbine combined power generation system according to a third embodiment.

FIG. 7

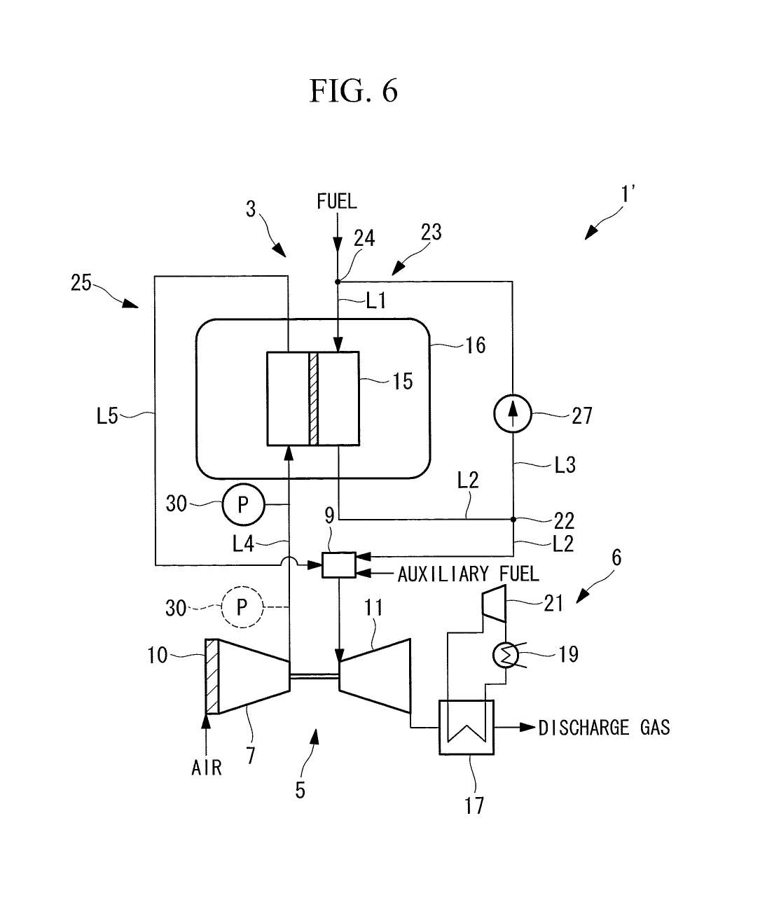

A control block diagram showing the control to detect a change in pressure of the high temperature fuel cell gas turbine combined power generation system in FIG. 6.

### DESCRIPTION OF EMBODIMENTS

Next, embodiments according to the present invention will be described while referring to the drawings.

### First Embodiment

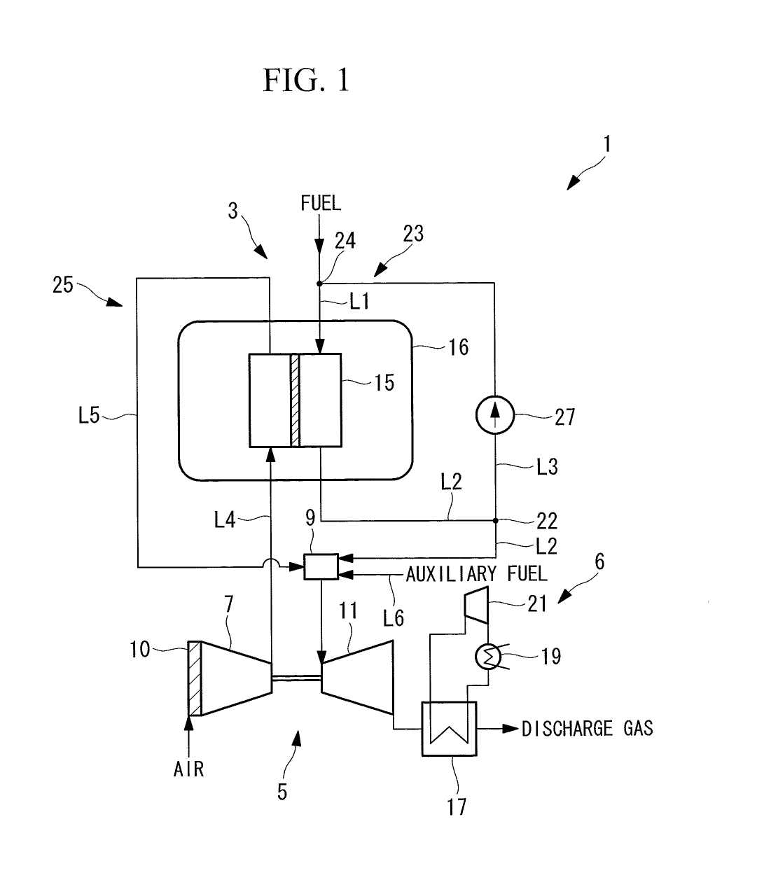

FIG. 1 illustrates a high temperature fuel cell and a gas turbine combined power generation system 1 according to a first embodiment. The high temperature fuel cell and the gas turbine combined power generation system 1 includes a solid oxide fuel cell 3 (hereafter referred to as “SOFC”) which is a high temperature fuel cell, a gas turbine system 5, and a steam turbine system 6.

The gas turbine system 5 includes a compressor 7 that compresses air, a combustor 9 that burns air and fuel gas, a gas turbine 11 that is driven to rotate by combustion gas discharged from the combustor 9, and a generator (not illustrated) that generates electrical power from the rotational power of the gas turbine 11.

An inlet guide vane (hereafter referred to as “IGV”) 10 is provided on the air intake side of the compressor 7 to control the intake air flow rate. By adjusting the degree of opening of the IGV 10 using a control unit, which is not illustrated on the drawings, the intake air flow rate can be controlled.

Discharge fuel gas that is guided from an SOFC main unit 15 is guided to the combustor 9 via a fuel gas discharge line L2. Also, auxiliary fuel is directly supplied to the combustor 9 from a fuel gas source, which is not illustrated on the drawings, via an auxiliary fuel gas supply line L6. The flow rate of the auxiliary fuel is adjusted by the control unit to a specific proportion of the fuel gas guided from the fuel gas discharge line L2. Gasified liquefied natural gas (LNG) is used, for example, as the fuel gas.

In addition, discharge air that is guided from the SOFC main unit 15 is guided to the combustor 9 via an air discharge line L5.

A discharge gas boiler 17 is provided on a discharge gas line on the downstream side of the gas turbine 11. Condensed water guided from a condenser 19 is heated by the discharge gas boiler 17 to generate steam.

The steam turbine system 6 includes a steam turbine 21 that is driven to rotate by steam guided from the discharge gas boiler 17, the condenser 19 that liquefies steam that has completed its work in the steam turbine 21, and a generator (not illustrated on the drawings) that is driven by the steam turbine 21 to generate electrical power.

The SOFC 3 mainly includes the SOFC main unit 15, a fuel system 23 connected to a fuel electrode side of the SOFC main unit 15, and an air system 25 that is connected to an air electrode side of the SOFC main unit 15.

The SOFC main unit 15 is disposed within a sealed container 16, and although this is not a limitation in particular, and includes, for example, a plurality of cylindrical-shaped ceramic fuel cell pipes (hereafter simply referred to as “cell pipes”). The cell pipes are constituted from a plurality of cells arranged in the axial direction on the outer surface of a base pipe. A cell is constituted from a fuel electrode membrane, an electrolyte membrane, and an air electrode membrane. Also, an interconnector is provided between cells.

By supplying fuel gas containing hydrogen or carbon monoxide to the fuel electrode membrane (anode electrode) and supplying oxidizing agent gas containing oxygen to the air electrode membrane (cathode electrode), the cell generates electromotive force at the two edges of the electrolyte membrane by causing a reaction for the synthesis of water or carbon dioxide.

The fuel electrode membrane is formed from, for example, nickel/yttria-stabilized zirconia. The electrolyte membrane is formed from yttria-stabilized zirconia, for example. The air electrode membrane is formed from, for example, lanthanum manganate. The interconnector membrane electrically connects adjacent cells together, and is formed from, for example, lanthanum chromite.

The fuel system 23 includes a fuel gas supply line L1 that supplies fuel gas from a fuel gas source, which is not illustrated on the drawings, to the fuel electrode side of the SOFC main unit 15, and the fuel gas discharge line L2 that guides discharge fuel gas that is discharged from the fuel electrode side of the SOFC main unit 15 to the combustor 9. Also, the fuel system 23 includes a fuel gas re-circulation line L3 that branches from a branch point 22 at an intermediate position on the fuel gas discharge line L2, and is connected to a confluence point 24 on the fuel gas supply line L1. Here, preferably, the fuel gas is reformed by reforming means, which is not illustrated on the drawings, into fuel gas that contains hydrogen or carbon monoxide on the fuel gas supply line L1 or in the SOFC main unit 15.

A fuel gas re-circulation blower 27 is provided on the fuel gas re-circulation line L3 to impel the discharge fuel gas that has branched from the fuel gas discharge line L2 toward the fuel gas supply line L1. As a result of the fuel gas re-circulation line L3, the fuel usage percentage is increased by re-circulating the unused fuel, and it is possible to ensure the water vapor necessary for the reforming reaction by feeding water vapor obtained from the power generation reaction of the SOFC main unit 15 to the fuel system 23.

The air system 25 includes an air supply line L4 that guides discharge air from the compressor 7 to the SOFC main unit 15, and the air discharge line L5 that guides discharge air discharged from the air electrode side of the SOFC main unit 15 to the combustor 9.

The high temperature fuel cell and the gas turbine combined power generation system 1 configured as described above has the following action.

A gas turbine load command value corresponding to the electrical power output by the gas turbine system 5 is determined by the control unit in accordance with the demands of the system side to which the power is supplied. When the gas turbine load command value is determined, an SOFC 3 load command value corresponding to the gas turbine load command value is determined as an SOFC normal load command value. The SOFC normal load command value is determined as a specific proportion of the gas turbine load command value. In other words, the SOFC normal load command value is determined in association with the gas turbine load command value.

When the gas turbine load command value and the SOFC normal load command value are determined, the fuel gas quantity and the air quantity are determined in accordance with the sum of their loads. Fuel gas is guided from the fuel gas source to the SOFC main unit 15 via the fuel gas supply line L1 so that the determined fuel gas quantity is supplied. Also, the degree of opening of the IGV 10 is adjusted to a specific value by the control unit so that the determined quantity of air is supplied, and after the air is drawn in from the IGV 10 and compressed in the compressor 7, the compressed air is guided to the SOFC main unit 15 via the air supply line L4.

Within the SOFC main unit 15 into which the fuel gas and compressed air have been guided, electrical power is generated by the fuel cell reaction.

The fuel gas for which the reaction has terminated in the SOFC main unit 15 is guided to the combustor 9 together with unreacted fuel gas, via the fuel gas discharge line L2. A portion of the discharge fuel gas is supplied to the fuel gas supply line L1 via the fuel gas re-circulation line L3 and reused.

Air for which the reaction has terminated in the SOFC main unit 15 is guided to the combustor 9 via the air discharge line L5.

In the combustor 9, the discharge fuel gas that is guided from the fuel gas discharge line L2 together with the auxiliary fuel gas that is guided via the auxiliary fuel gas supply line L6 is burned with the discharge air guided from the air discharge line L5.

The high temperature and high pressure combustion gas generated in the combustor 9 is guided to the gas turbine 11 to drive the rotation of the gas turbine 11. The generator, which is not illustrated on the drawings, is driven by the rotational drive of the gas turbine 11 to generate electrical power.

The discharge gas discharged from the gas turbine 11 is released to the atmosphere from a flue, which is not illustrated on the drawings, after heating condensed water in the discharge gas boiler 17.

Steam that is heated and generated in the discharge gas boiler 17 is guided to the steam turbine 21 to drive the rotation of the steam turbine 21. As a result of this rotational drive of the steam turbine 21, the generator, which is not illustrated on the drawings, is driven to generate electrical power. The steam that has completed its work in the steam turbine 21 is guided to the condenser 19 and liquefied to become condensed water.

Next, the control during transient periods when the gas turbine load command value changes is described.

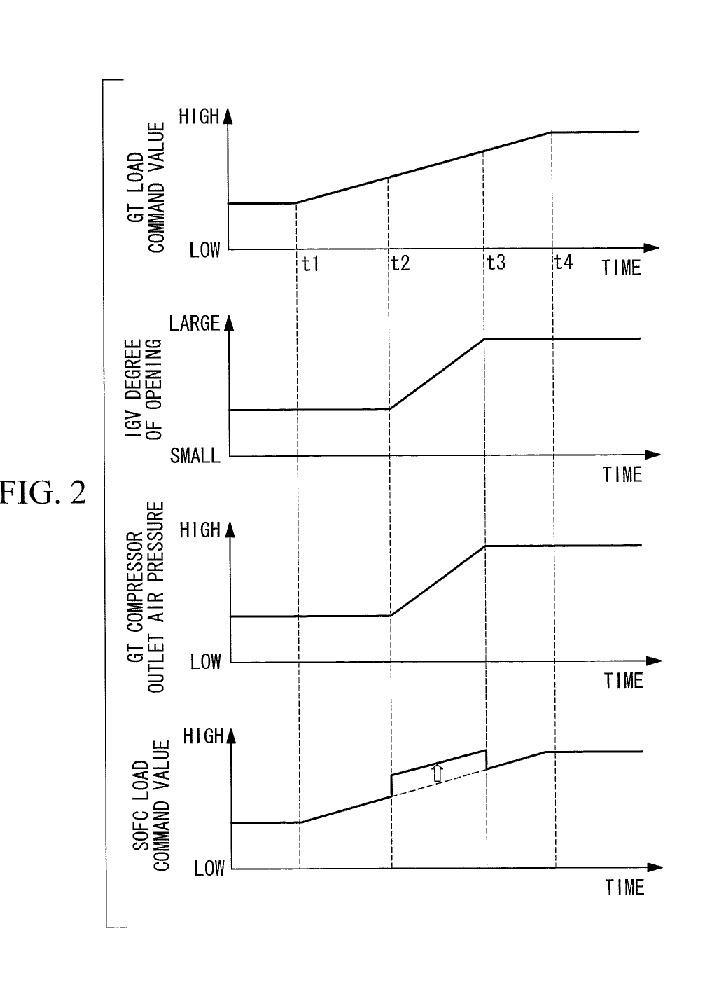

FIG. 2 shows the control in the case that the gas turbine load command value is increased.

As shown in this drawing, when the gas turbine load control value is increased from the time t1, the SOFC load command value coupled therewith likewise increases from the time t1. At this time, the SOFC load command value is the SOFC normal load command value that is determined coupled with the gas turbine load command value.

At time t2, the degree of opening of the IGV 10 is increased in order that the air flow rate will increase and the gas turbine system internal pressure will increase. When the degree of opening of the IGV 10 is increased, the pressure of the air flowing from an outlet of the compressor 7 toward the SOFC main unit 15 (the pressure of the air supply line L4) increases.

The control unit detects the start of the increase of the degree of opening of the IGV 10 at time t2 (for example, the air pressure increases from 0.65 to 1.15 MPa), and increases the SOFC load command value to a pressure increasing period load command value that is the SOFC load command value increased from the normal command value by a specific value.

At time t3 (for example, air pressure increases from 1.3 to 2.3 MPa), the degree of opening of the IGV 10 reaches a specific value, and becomes constant. Accordingly, the pressure of the air flowing from the outlet of the compressor 7 toward the SOFC main unit 15 (the pressure in the air supply line L4) also becomes constant.

The control unit detects that the change in degree of opening of the IGV 10 has terminated at time t3, and the SOFC load command value is reduced from the pressure increasing period load command value to the normal load command value.

Then, at time t4, the gas turbine load command value reaches a specific load, and the load is controlled to be constant. At time t4, the SOFC load command value coupled therewith is controlled to be constant.

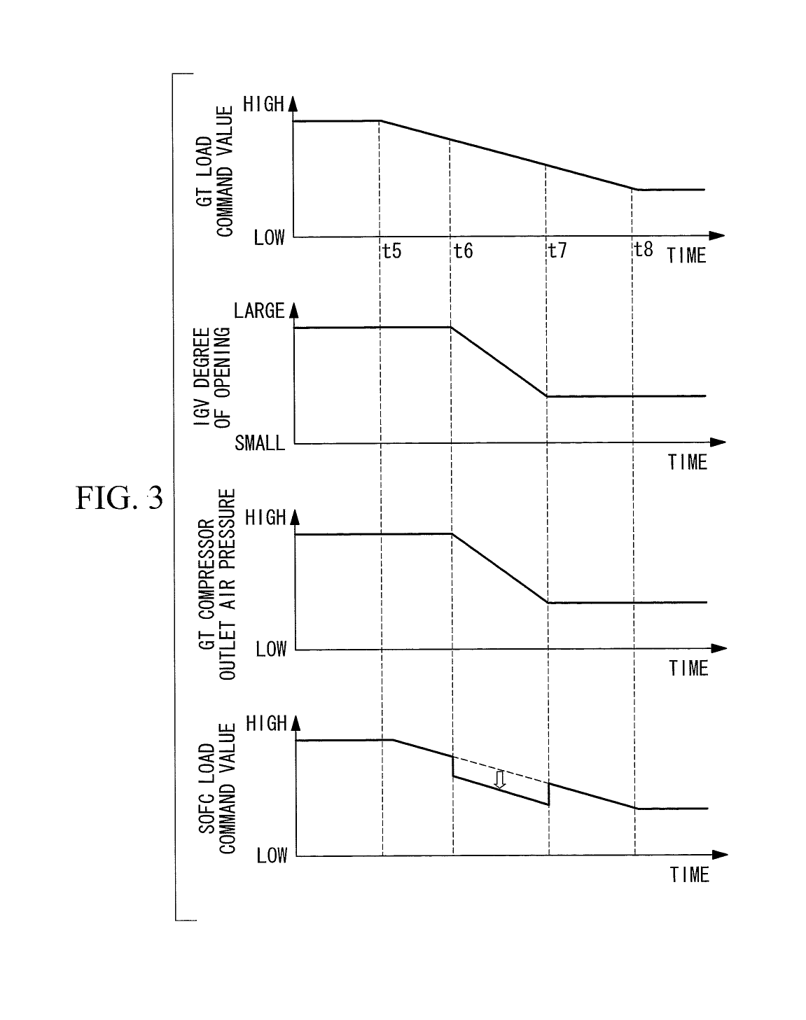

FIG. 3 shows the control in the case that the gas turbine load command value is decreased.

As shown in this drawing, when the gas turbine load command value is decreased from the time t5, the SOFC load command value coupled therewith likewise decreases from the time t5. At this time, the SOFC load command value is the SOFC normal load command value that is determined coupled with the gas turbine load command value.

At time t6, the degree of opening of the IGV 10 is decreased in order that the air flow rate will decrease and the gas turbine system internal pressure will decrease. When the degree of opening of the IGV 10 is decreased, the pressure of the air flowing from the outlet of the compressor 7 toward the SOFC main unit 15 (the pressure of the air supply line L4) is decreased.

The control unit detects the start of the decrease of the degree of opening of the IGV 10 at time t6, and decreases the SOFC load command value to a pressure decreasing period load command value that is the SOFC load command value decreased from the normal command value by a specific value.

At time t7, the degree of opening of the IGV 10 reaches a specific value, and becomes constant. Accordingly, the pressure of the air flowing from the outlet of the compressor 7 toward the SOFC main unit 15 (the pressure in the air supply line L4) also becomes constant.

The control unit detects that the change in degree of opening of the IGV 10 has terminated at time t7, and the SOFC load command value is increased from the pressure decreasing period load command value to the normal load command value.

Then, at time t8, the gas turbine load command value reaches a specific load, and the load is controlled to be constant. At time t8, the SOFC load command value coupled therewith is controlled to be constant.

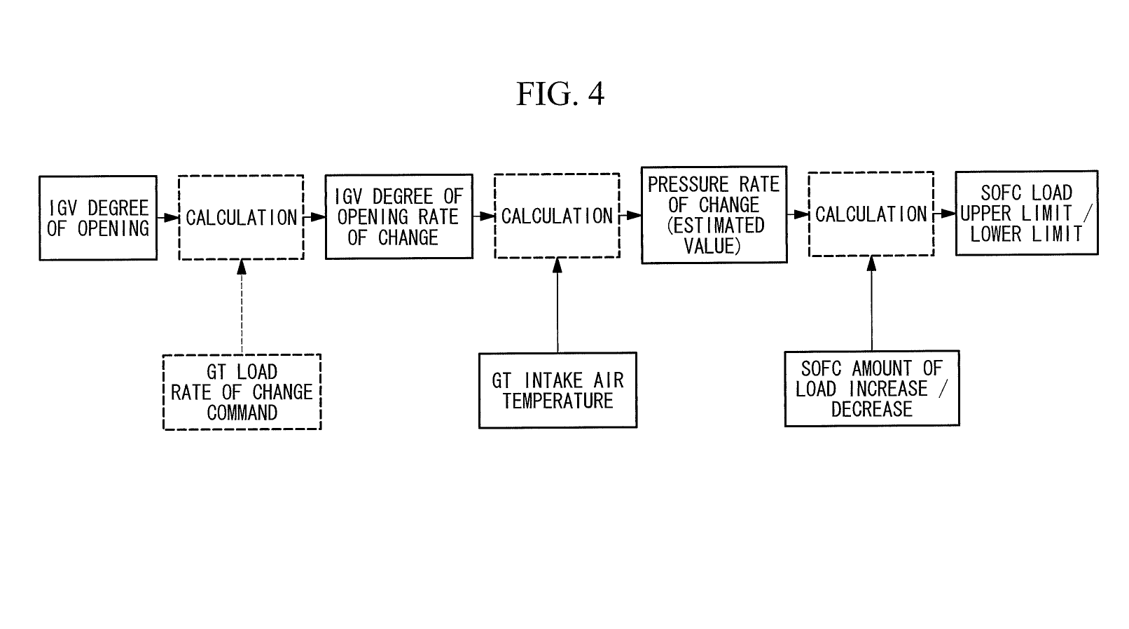

FIG. 4 shows a control block diagram for determining the SOFC load command value by the control unit.

The control unit obtains the degree of opening of the IGV 10 at each time from the measurement value of a degree of opening detection sensor, and calculates the IGV degree of opening rate of change. On the other hand, the control unit obtains the intake air temperature of the gas turbine (GT) from the measurement values of a temperature sensor. Then, the pressure change obtained from the IGV degree of opening rate of change is corrected with the GT intake air temperature, to calculate an estimated value of the rate of change of the pressure of the discharge air at the compressor 7 outlet.

Next, based on the rate of change of pressure obtained from the calculation, SOFC load command values are calculated so that an upper limit setting value and a lower limit setting value are not exceeded, and the amount of increase of the pressure increasing period load command value or the amount of decrease of the pressure decreasing period load command value is determined.

As indicated by the broken lines in FIG. 4, instead of directly measuring the degree of opening using the degree of opening detection sensor described above, the change in the degree of opening of the IGV 10 may be estimated from the rate of change of the degree of opening of the IGV 10 calculated from the load rate of change command value applied to the gas turbine system 5.

In this way, in this embodiment, as shown in FIG. 2, in the transient period when the gas turbine load command value is changed and the air flow rate supplied to the SOFC main unit 15 is increased, the SOFC load command value is set to the pressure increasing period load command value from the SOFC normal load command value. As a result, during pressure increasing periods when the pressure of the air supplied to the SOFC main unit 15 is transiently increasing, the pressure increasing period load command value which is increased by a specific value with respect to the SOFC normal load command value is applied, and the fuel gas is increased corresponding to the amount that the load was increased over the SOFC normal load command value, and supplied within the SOFC main unit 15. In this way, during periods of transient pressure increase, the flow rate of discharge fuel gas supplied from the SOFC main unit 15 to the combustor 9 can be maintained approximately constant with respect to the auxiliary fuel gas.

Also, in this embodiment, as shown in FIG. 3, in transient periods when the degree of opening of the IGV 10 is reduced, the SOFC load command value is set to the pressure decreasing period load command value from the SOFC normal load command value. As a result, during pressure decreasing periods when the pressure of the air supplied to the SOFC main unit 15 is transiently decreasing, the pressure decreasing period load command value which is decreased by a specific value with respect to the SOFC normal load command value is applied, and the fuel gas is decreased corresponding to the amount that the load was decreased over the SOFC normal load command value, and supplied within the SOFC main unit 15. In this way, during periods of transient pressure decrease, the flow rate of discharge fuel gas supplied from the SOFC main unit 15 to the combustor 9 can be maintained approximately constant with respect to the auxiliary fuel gas.

In this way, according to this embodiment, when the pressure of the air supplied to the SOFC main unit 15 is transiently increased or decreased, it is possible to control the ratio of the discharge fuel gas and the auxiliary fuel gas supplied to the combustor 9 of the gas turbine system 5, namely, the fuel composition, to be approximately constant. Therefore, it is possible to avoid unstable combustion and to prevent an increase in NOx, combustion vibrations, accidental fires, and the like, in the combustor 9.

### Second Embodiment

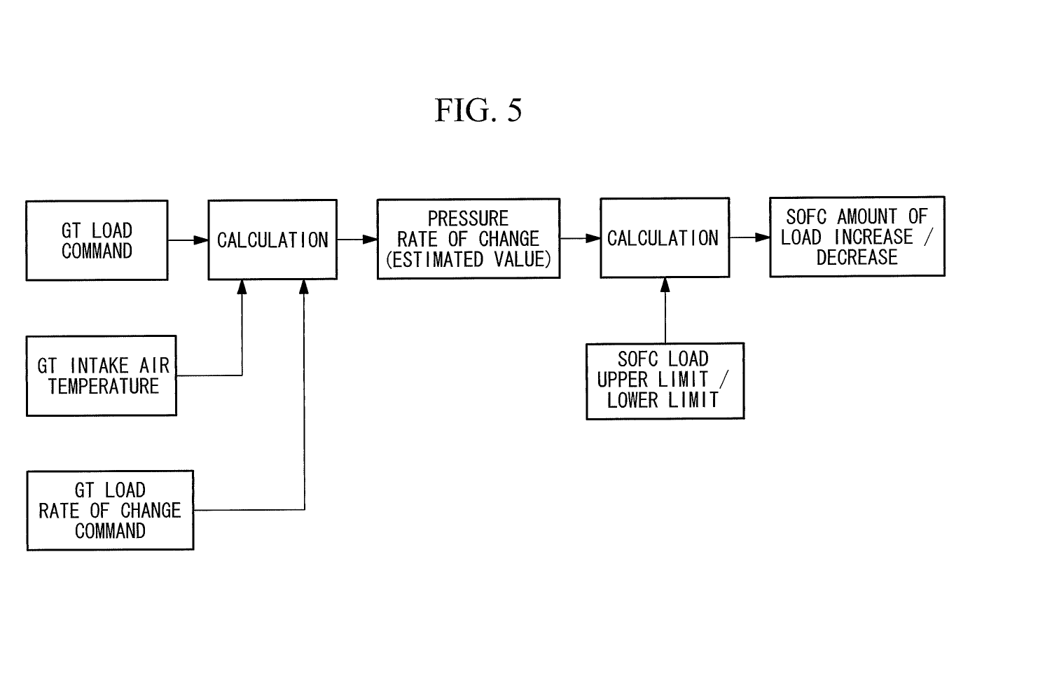

A second embodiment of the present invention will be described below using FIG. 5.

In this embodiment, the method of detecting an increase or decrease of the pressure of the air supplied to the SOFC main unit 15 is different from that of the first embodiment, and the rest of the configuration is the same. Therefore, in the following, the method of detecting an increase or decrease of the air pressure is described.

As illustrated in FIG. 5, in this embodiment, the change in the pressure of the air supplied to the SOFC main unit 15 is obtained without using the degree of opening of the IGV 10 as in the first embodiment. The control unit performs a calculation using the gas turbine load command GT load command), the gas turbine intake air temperature (GT intake air temperature), and the gas turbine rate of change of load command (GT rate of change of load command), to estimate the rate of change of pressure of the air supplied to the SOFC main unit 15. Then, based on the rate of change of pressure obtained from the calculation, SOFC load command values are calculated so that an upper limit setting value and a lower limit setting value are not exceeded, and the amount of increase of the pressure increasing period load command value or the amount of decrease of the pressure decreasing period load command value is determined.

In this way, according to this embodiment, it is possible to use the GT rate of change of load command, which is an antecedent command value of the IGV degree of opening, without using the degree of opening of the IGV 10, so it is possible to further increase the responsiveness.

### Third Embodiment

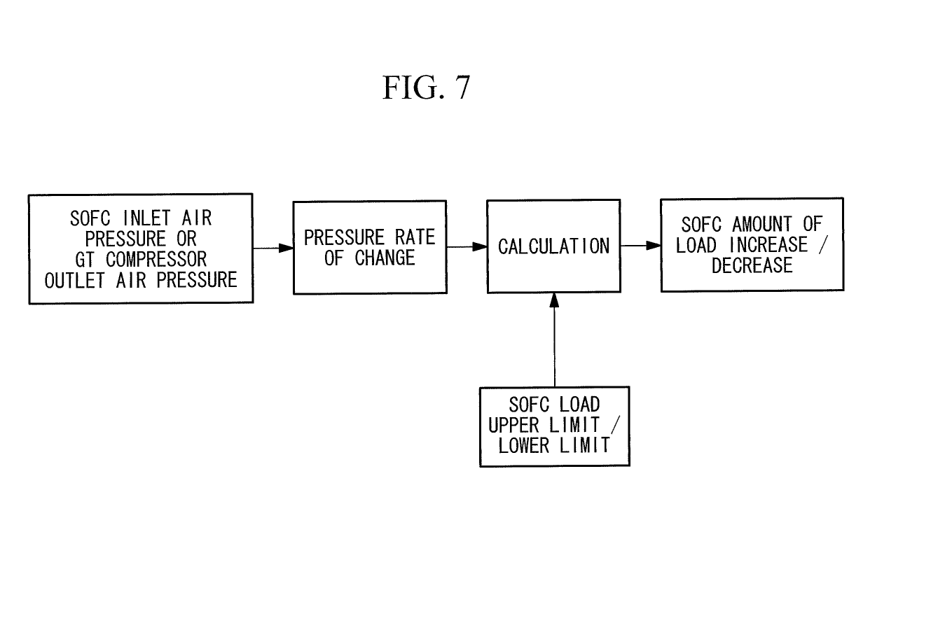

A third embodiment of the present invention will be described below using FIG. 6 and FIG. 7.

In this embodiment, the method of detecting an increase or decrease of the pressure of the air supplied to the SOFC main unit 15 is different from that of each of the embodiments described above.

FIG. 6 illustrates a high temperature fuel cell and the gas turbine combined power generation system 1′ according to the present embodiment. The combined power generation system 1′ differs from the first embodiment illustrated in FIG. 1 in that a pressure sensor 30 is additionally provided to the air supply line L4, but is otherwise the same. Therefore, the same reference numerals are given to the configuration that is common, and their description is omitted.

The pressure sensor 30 is provided near the inlet of the SOFC main unit 15. In this way, it is possible to detect the pressure of the air supplied to the SOFC main unit 15. The measurement data detected by the pressure sensor 30 is sent to the control unit. As indicated by the broken lines in FIG. 6, the pressure sensor 30 may be installed near the outlet of the compressor 7 on the air supply line L4, in order to detect the pressure of the air discharged from the compressor 7.

As shown in FIG. 7, the control unit obtains the SOFC main unit 15 inlet air pressure or the gas turbine outlet air pressure (GT outlet air pressure) from the measurement results by the pressure sensor 30, and obtains the rate of change of pressure of the air supplied to the SOFC main unit 15. Then, based on the rate of change of pressure obtained from the measurement, SOFC load command values are calculated so that an upper limit setting value and a lower limit setting value are not exceeded, and the amount of increase of the pressure increasing period load command value or the amount of decrease of the pressure decreasing period load command value is determined.

In this way, according to this embodiment, the pressure of the air supplied to the SOFC main unit 15 is directly measured using the pressure sensor 30, so it is possible to carry out control with high accuracy.

In the embodiments as described above, the solid oxide fuel cell (SOFC) was used in the description as an example of high temperature fuel cell. However, the present invention is not limited thereto, and another high temperature fuel cell that operates at 500° C. or higher can be used such as, for example, a molten carbonate fuel cell (MCFC).

### REFERENCE SIGNS LIST

1, 1′ High temperature fuel cell and gas turbine combined power generation system
3 Solid oxide fuel cell (high temperature fuel cell)
5 Gas turbine system
6 Steam turbine system
7 Compressor
9 Combustor
10 IGV (flow rate control vane)
11 Gas turbine
15 SOFC main unit (high temperature fuel cell main unit)
16 Sealed container
19 Condenser
21 Steam turbine
22 Branch point
23 Fuel system
24 Confluence point
25 Air system
27 Fuel gas re-circulation blower
30 Pressure sensor
L1 Fuel gas supply line
L2 Fuel gas discharge line
L3 Fuel gas re-circulation line
L4 Air supply line
L5 Air discharge line
L6 Auxiliary fuel gas supply line

1. A combined power generation system that includes a gas turbine system and a high temperature fuel cell, the gas turbine system including a compressor, a combustor, a gas turbine, and a generator, the combined power generation system comprising:
a high temperature fuel cell main unit to which fuel gas and air are supplied and which generates electrical power;
a fuel gas supply line that supplies fuel gas from a fuel gas source to the high temperature fuel cell main unit;
a fuel gas discharge line that guides discharge fuel gas discharged from the high temperature fuel cell main unit to the combustor;
an air supply line that supplies discharge air from the compressor to the high temperature fuel cell main unit;
an air discharge line that guides discharge air discharged from the high temperature fuel cell main unit to the combustor;
an auxiliary fuel gas supply line that supplies fuel gas to the combustor separately from the fuel gas discharge line; and
a control unit that adjusts the fuel gas quantity supplied to the high temperature fuel cell main unit by applying a load corresponding to the load of the gas turbine system to the high temperature fuel cell main unit as a normal load command value,
wherein,
during pressure increasing periods when the pressure of the air supplied into the high temperature fuel cell main unit via the air supply line is increasing transiently, the control unit increases the load applied to the high temperature fuel cell main unit by increasing the normal load command value by a specific value as a pressure increasing period load command value,
and/or,
during pressure decreasing periods when the pressure of the air supplied to the high temperature fuel cell main unit via the air supply line is decreasing transiently, the control unit decreases the load applied to the high temperature fuel cell main unit by decreasing the normal load command value by a specific value as a pressure decreasing period load command value.

2. The combined power generation system according to claim 1, wherein the control unit detects the transient change in pressure of the air supplied to the high temperature fuel cell main unit based on a change in a degree of opening of a flow rate control vane that controls the intake air flow rate of the compressor.

3. The combined power generation system according to claim 1, wherein the control unit detects the transient change in pressure of the air supplied to the high temperature fuel cell main unit based on a load rate of change command value provided to the gas turbine system.

4. The combined power generation system according to claim 1, wherein the control unit detects the transient change in pressure of the air supplied to the high temperature fuel cell main unit based on the pressure of the air supply line.

5. An operation method for a combined power generation system that includes a gas turbine system and a high temperature fuel cell, the gas turbine system including a compressor, a combustor, a gas turbine, and a generator,
the combined power generation system including: a high temperature fuel cell main unit to which fuel gas and air are supplied and which generates electrical power;
a fuel gas supply line that supplies fuel gas from a fuel gas source to the high temperature fuel cell main unit;
a fuel gas discharge line that guides discharge fuel gas discharged from the high temperature fuel cell main unit to the combustor;
an air supply line that supplies discharge air from the compressor to the high temperature fuel cell main unit;
an air discharge line that guides discharge air that is discharged from the high temperature fuel cell main unit to the combustor;
an auxiliary fuel gas supply line that supplies fuel gas to the combustor separately from the fuel gas discharge line; and
a control unit that adjusts the fuel gas quantity supplied to the high temperature fuel cell main unit by applying a load corresponding to the load of the gas turbine system to the high temperature fuel cell main unit as a normal load command value,
wherein,
during pressure increasing periods when the pressure of the air supplied to the high temperature fuel cell main unit via the air supply line is increasing transiently, the control unit increases the load applied to the high temperature fuel cell main unit by increasing the normal load command value by a specific value as a pressure increasing period load command value,
and/or,
during pressure decreasing periods when the pressure of the air supplied to the high temperature fuel cell main unit via the air supply line is decreasing transiently, the control unit decreases the load applied to the high temperature fuel cell main unit by decreasing the normal load command value by a specific value as a pressure decreasing period load command value.
